(19) United States
(12) Patent Application Publication
(10) Pub. No.: US 2008/0210236 A1
(43) Pub. Date: Sep. 4, 2008

(54) Tubing management system

(75) Inventors: Ron Richard, Temecula, CA (US); Christen Pettit, San Diego, CA (US); Robert Edward Henry, Roseville (AU); Philip Rodney Kwok, Chatswood (AU); Philip John Gunning, North Rocks (AU); Susan Robyn Lynch, Epping (AU); Gerard Michael Rummery, Linden (AU); Rupert Christian Scheiner, Davidson (AU)

Correspondence Address: NIXON & VANDERHYE, PC, 901 NORTH GLEBE ROAD, 11TH FLOOR, ARLINGTON, VA, 22203, US

(73) Assignee: ResMed Limited, Bella Vista (AU)

(21) Appl. No.: 12/073,112

(22) Filed: Feb. 29, 2008

Related U.S. Application Data
(60) Provisional application No. 60/904,181, filed on Mar. 1, 2007.

(51) Int. Cl. A62B 7/02; A44B 21/00

(52) U.S. Cl. 128/204.23; 24/305

(57) ABSTRACT

A tubing management system for a CPAP system includes a pillow including at least one port through an interior portion thereof. Each port includes an inlet and an outlet that is adapted to be coupled to an air delivery conduit to allow the air delivery conduit to be routed through the interior portion.

### CROSS-REFERENCE TO APPLICATION

This application claims the benefit of U.S. Provisional Application No. 60/904,181, filed Mar. 1, 2007, which is incorporated herein by reference in its entirety.

### FIELD OF THE INVENTION

The present invention relates to a tubing management system for managing tubing used in an air delivery system for treatment, e.g., of Sleep Disordered Breathing (SDB) with Continuous Positive Airway Pressure (CPAP) or Non-Invasive Positive Pressure Ventilation (NIPPV).

### BACKGROUND OF THE INVENTION

Apparatus to deliver breathable gas to a patient typically include a flow generator, an air delivery conduit, and a patient interface, wherein the air delivery conduit delivers pressurized air from the flow generator to the patient interface in contact with the patient's face.

The air delivery conduit typically used in CPAP therapy has been tubing with a diameter of 22 mm. This tubing is bulky and can prove difficult to manage, which in turn may lead to drag on the headgear of the patient interface, system instability, patient discomfort, and/or leakage. In addition, as CPAP therapy is generally conducted in the home, this tubing can make patients apprehensive in adopting the therapy because the tubing can look out of place amongst the environment commonly found in a patient's bedroom. That is, the tubing and related CPAP equipment does not blend with the bedroom environment which may stigmatize the patient and lead to poor compliance.

Thus, a need has developed in the art to provide alternatives for management of the tubing to not only improve patient comfort, compliance, and interface stability, but to truly integrate the tubing into the bedroom environment.

Exemplary systems for enhancing CPAP therapy are disclosed in U.S. Pat. No. 7,086,422 and U.S. patent application Ser. Nos. 11/483,564 and 11/494,522, each of which is incorporated herein by reference in its entirety, as well as Respironics' ComfortCurve™ and Hoffman Laboratory's BreatheX CPAP device.

### SUMMARY OF THE INVENTION

One aspect of the invention relates to a tubing management system adapted to control tube routing, sound transmission or acoustics, air temperature, and/or air humidity through arrangements in a pillow or mattress.

Other aspects of the invention relate to management of the patient's head position in order to open the upper airway, tubing configurations, and clips to support tubing.

Another aspect of the invention relates to a tubing management system for a CPAP system. The tubing management system includes a pillow including at least one port through an interior portion thereof. Each port includes an inlet and an outlet that is adapted to be coupled to an air delivery conduit to allow the air delivery conduit to be routed through the interior portion.

Another aspect of the invention relates to a tubing management system for a CPAP system. The tubing management system includes a base or insert including at least one port through an interior portion thereof. The base or insert is adapted to lie under a pillow or mattress and the at least one port is adapted to be coupled to an air delivery conduit to allow the air delivery conduit to be routed through the interior portion.

Another aspect of the invention relates to a tubing kit including at least two tubing segments and at least one connector adapted to connect the at least two tubing segments to one another to construct a tube of customized length.

Another aspect of the invention relates to a CPAP system including a flow generator, a patient interface, and an air delivery conduit including a spiral configuration that interconnects the flow generator and the patient interface.

Another aspect of the invention relates to a tube retainer including a clip portion adapted to be attached to the patient's pillow or mattress and a tube connector portion adapted to be coupled between first and second tubes. The tube connector portion includes a first side structured to be attached to the first tube and a second side structured to be attached to the second tube.

Another aspect of the invention relates to a tube retainer including a first portion adapted to be attached to a tube and a second portion that provides an opening adapted to receive a selected attachment structure provided on the patient's shirt or pajamas.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a tubing management system including a pillow according to an embodiment of the present invention;

FIG. 2 is a perspective view of a tubing management system including a pillow according to another embodiment of the present invention;

FIG. 3 is a perspective view of a tubing management system including a pillow base or insert according to an embodiment of the present invention;

FIG. 4 is a perspective view of a tubing management system including a mattress base according to an embodiment of the present invention;

FIG. 5 is a side view of contoured pillow including a port according to an embodiment of the present invention;

FIG. 6 is a perspective view of an air delivery conduit including tubing segments according to an embodiment of the present invention;

FIG. 7 is a perspective view of a patient interface including spiral tubing according to an embodiment of the present invention;

FIG. 8 is a perspective view of a clip according to an embodiment of the present invention;

FIG. 9 is a perspective view of an air delivery conduit including a tube retainer according to an embodiment of the present invention; and

FIG. 10 is a perspective view of an air delivery conduit including a tube retainer according to another embodiment of the present invention.

### DETAILED DESCRIPTION OF ILLUSTRATED EMBODIMENTS

The following description is provided in relation to several embodiments which may share common characteristics and features. It is to be understood that one or more features of any one embodiment may be combinable with one or more features of the other embodiments. In addition, each single feature or combination of features in any of the embodiments may constitute an additional embodiment.

In this specification, the word “comprising” is to be understood in its “open” sense, that is, in the sense of “including”, and thus not limited to its “closed” sense, that is the sense of “consisting of”. A corresponding meaning is to be attributed to the corresponding words “comprise”, “comprised” and “comprises” where they appear.

The term “air” will be taken to include breathable gases, for example air with supplemental oxygen. It is also acknowledged that the flow generators or blowers described herein may be designed to pump fluids other than air.

### 1. CPAP System

A CPAP system generally includes a flow generator, an air delivery conduit or tubing, and a patient interface. In use, the flow generator generates a supply of pressurized air that is delivered to the patient via an air delivery conduit that includes one end coupled to the outlet of the flow generator and an opposite end coupled to the patient interface. The patient interface comfortably engages the patient's face and provides a seal. The patient interface may have any suitable configuration as is known in the art, e.g., full-face mask, nasal mask, oro-nasal mask, mouth mask, nasal prongs, etc. Also, headgear may be utilized to comfortably support the patient interface in a desired position on the patient's face.

### 2. Tubing Management System

The following provides tubing management systems according to embodiments of the present invention. Each tubing management system is structured to manage routing of the air delivery conduit from the flow generator to the patient interface in use.

### 2.1 Tubing Routed Through Pillow

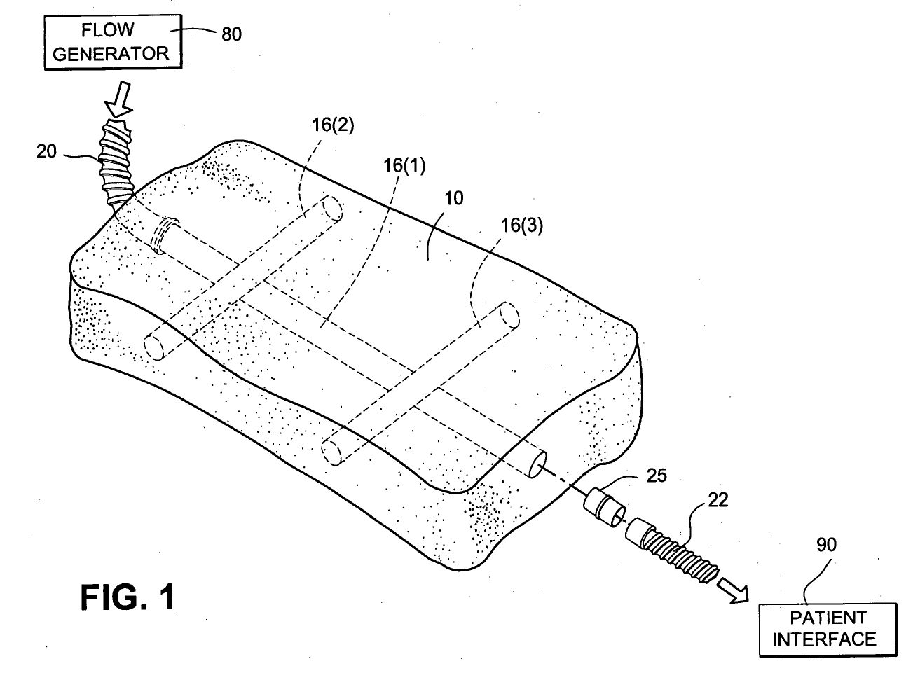

FIG. 1 illustrates a tubing management system including a pillow 10 structured to allow air delivery tubing to be routed therethrough. In the illustrated embodiment, the pillow 10 includes a multi-port configuration wherein multiple ports 16(1), 16(2), 16(3) extend through the pillow. Each port can either be blocked (e.g., via plugs provided to inlet and outlet sides of the port) or coupled to the air delivery conduit. The multi-port configuration provides a variety of options for the patient who may prefer the tubing to extend from either of the sides or from the front or back of the pillow. In an alternative embodiment, the pillow may provide a single-port configuration wherein a single port extends through the pillow and provides a single inlet and outlet for coupling to the air delivery conduit. However, any suitable number of ports and port configurations through the pillow are possible.

In use, a first air delivery conduit 20 is coupled between the flow generator 80 and a selected inlet side of the selected port of the pillow 10, and a second air delivery conduit 22 is coupled between the patient interface 90 and a selected outlet side of the selected port of the pillow 10. A connector 25, e.g., swivel connector, may be provided to one or both ends of each air delivery conduit 20, 22 to couple the air delivery conduit 20, 22 to the respective component. In an embodiment, a 360° swivel connector may be connected to each side of the selected port to allow rotation of the air delivery conduits 20, 22 connected to respective sides of the port.

This arrangement allows the tubing to extend from selected sides of the pillow which may reduce drag, improve patient comfort, and improve bedroom aesthetics.

In an embodiment, the conduit 22 may be constructed of smaller bore tubing than the tubing of the conduit 20 to reduce drag. For example, the conduit 20 between the flow generator 80 and the pillow 10 may be constructed of 22 mm bore tubing and the conduit between the patient interface 90 and the pillow 10 may be constructed of 15 mm bore tubing. The pillow 10 will eliminate or reduce drag from the conduit 20 from being applied to the patient, and the drag from the conduit 22 will be relatively small due to the smaller size tubing and the relatively small tube length from the pillow 10 to the patient interface 90.

2.2 Soft Pliable Pillow with Semi or High Density Foam Core

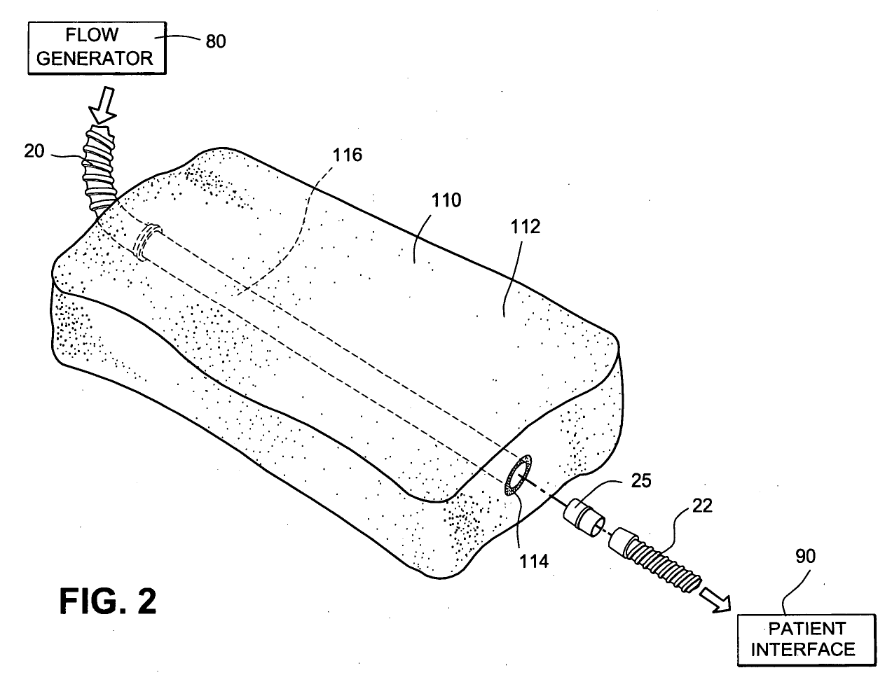

FIG. 2 illustrates a tubing management system including a pillow 110 structured to allow air delivery tubing to be routed through an interior portion thereof. As illustrated, the pillow 110 includes a soft pliable portion 112 constructed of a low density foam and a core portion 114 constructed of a semi or high density foam. The core portion 114 has a tubular configuration that defines a single port through the pillow. A piece of smooth tubing 116, e.g., 22 mm tubing, is routed through the core portion 114. However, multiple ports with multiple tubing through the pillow are possible.

In use, a first air delivery conduit 20 is coupled between the flow generator 80 and the selected inlet side of the tubing 116, and a second air delivery conduit 22 is coupled between the patient interface 90 and the selected outlet side of the tubing 116. A connector 25, e.g., swivel connector, may be provided to one or both ends of each air delivery conduit 20, 22 to couple the air delivery conduit 20, 22 to the respective component. In an embodiment, a 360° swivel connector may be connected to each side of the tubing 116 to allow rotation of the air delivery conduits 20, 22 connected to respective sides of the tubing 116.

The semi or high density foam core portion 114 of the pillow provides support and keeps the weight of the patient's head from possibly collapsing the tubing 116 and changing the flow and pressure curves of the pressurized gas being delivered to the patient in use.

### 2.3 Pillow Base or Insert

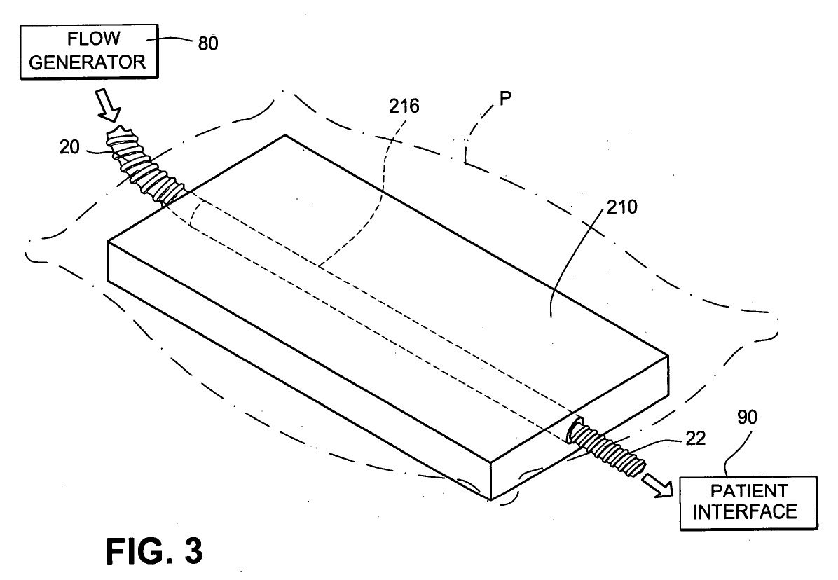

FIG. 3 illustrates a tubing management system including a pillow base or insert 210 structured to allow air delivery tubing to be routed through an interior portion thereof. As illustrated, the pillow base or insert 210 is adapted to lie under a pillow P (and possibly within the pillow slip) in use.

In the illustrated embodiment, the pillow base or insert 210 provides a single port 216 therethrough. However, multiple ports through the base or insert 210 are possible. The pillow base or insert 210 may be constructed of a material that prevents collapse of the port 216 in use, e.g., semi or high density foam.

In use, a first air delivery conduit 20 is coupled between the flow generator 80 and the selected inlet side of the port 216, and a second air delivery conduit 22 is coupled between the patient interface 90 and the selected outlet side of the port 216. A connector, e.g., swivel connector, may be provided to one or both ends of each air delivery conduit 20, 22 to couple the air delivery conduit 20, 22 to the respective component.

The pillow base or insert 210 allows the patient to use his/her current pillow. In an embodiment, the pillow base or insert 210 may sit under the pillow P and may be coated with silicone or other suitable material that would prevent the pillow base or insert 210 from sliding around the bed in use.

### 2.4 Mattress Base

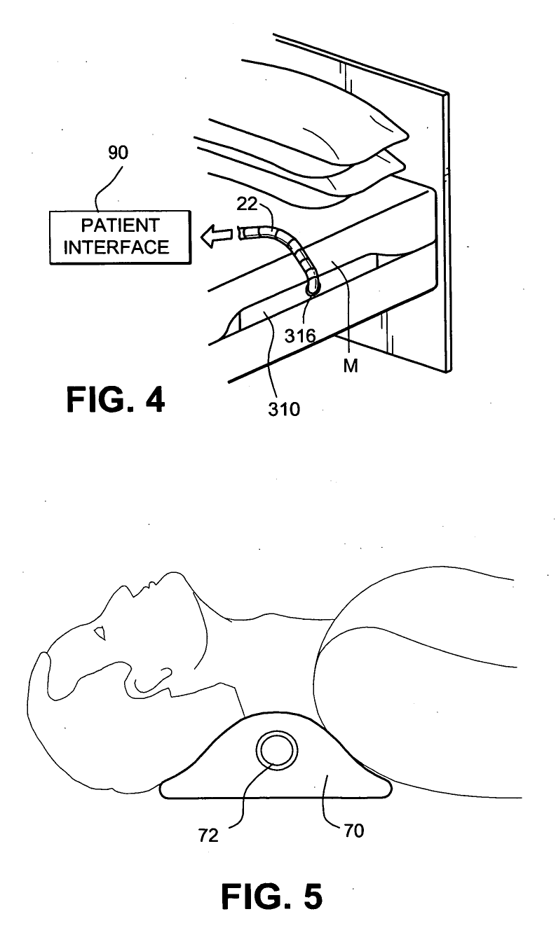

Similar to the pillow base or insert described above, a tubing management system may be provided that is adapted to lie between the bed mattress and the bed frame or box spring in use. For example, FIG. 4 illustrates a tubing management system including a mattress base 310 structured to allow air delivery tubing to be routed through an interior port 316 thereof. In use, the mattress base 310 would lie under the mattress M and a first air delivery conduit is coupled between the flow generator and the selected inlet side of the port (not shown) and a second air delivery conduit 22 is coupled between the patient interface 90 and the selected outlet side of the port 316. This arrangement allows air delivery tubing to extend from one side of the mattress to the other side of the mattress.

In an alternative embodiment, the flow generator may be structured to lie under the mattress in use, along with the mattress base. Such a flow generator is disclosed in U.S. patent application Ser. No. 11/483,564, which is incorporated herein by reference in its entirety.

### 2.5 Air Management System

In addition to tube routing, each pillow, pillow base/insert, or mattress base described above may provide an air management system to control noise or sound transmission, temperature of the air, and/or or humidity of the air.

In an embodiment, a muffler may be provided along the port or tube incorporated into the pillow. In use, the muffler would help reduce noise being conducted from the flow generator. The muffler may be in the form of a large volume surrounded by a semi or high density material. The large volume would be structured to reduce the sound transmission and the semi or high density material would be structured to prevent transmission of the sound from the large volume (e.g., a large volume in a semi dense foam core).

In another embodiment, a heater may be provided along the port or tube incorporated into the pillow. In use, the heater would be operated to control the temperature and/or humidity of the air.

2.6 Pillow with Hinge

In an embodiment, each pillow, pillow base/insert, or mattress base described above may be structured to hinge open in order to access the ports and/or tubing therein, e.g., for cleaning, repair, assembly, rerouting, etc.

3. Contoured Positioning System with/without Tubing Management System

In addition to or in lieu of the tubing management systems described above, a contoured positioning system may be provided to manage the patient's head position in order to open the patient's upper airway in use. This system may improve the severity of snoring and/or sleep disorder breathing.

In an embodiment, the contoured positioning system may include a pillow to support the patient's head during sleep. The pillow would have a contoured shape structured to slightly tip or extend the patient's head back. This arrangement positions the patient's head and neck in such a way to open the patient's upper airway. Maintaining the patient's head in such an extended position during sleep may reduce resistance in the upper airway and lower overall mean pressures required to treat SDB symptoms. The pillow may be custom designed to promote neck extension for a specific patient.

In an embodiment, the pillow may incorporate one or ports for connecting and managing tubing in a manner as described above.

For example, FIG. 5 illustrates a pillow 70 having a contoured shape structured to extend the patient's head back, e.g., 1°-10° or about 5°, in such a way to open the patient's upper airway. Also, the pillow 70 includes a port 72 structured to allow air delivery tubing to be routed through an interior portion of the pillow. In an embodiment, the pillow may be contoured such as the pillow disclosed in U.S. Patent Application No. 60/881,156, filed Jan. 19, 2007, which is incorporated herein by reference in its entirety.

### 4. Tubing Configurations

The following provides air delivery conduit or tubing configurations according to embodiments of the present invention. Each tubing configuration is structured to facilitate use and improve compliance.

### 4.1 Segmented Tubing

In an embodiment, the air delivery conduit may be provided in relatively short tubing segments that may be coupled together in order to customize the length of the air delivery conduit. For example, the air delivery conduit may include at least two relatively short tubing segments that are coupled to one another by a connector, e.g., 360° swivel connector. Thus, the patient may select a tubing length equal to 1 tubing segment, 2 tubing segments, 3 tubing segments, etc. This arrangement allows the patient to select a tubing length that is comfortable and manageable for his/her particular usage of the PAP system. In addition, this arrangement facilitates cleaning as the tubing may be broken down into the relatively short tubing segments. Typically, the air delivery conduit includes a single 6-8 foot (about 2 m) piece of tubing, which tends to be cumbersome, difficult to manage during the night, and difficult to clean.

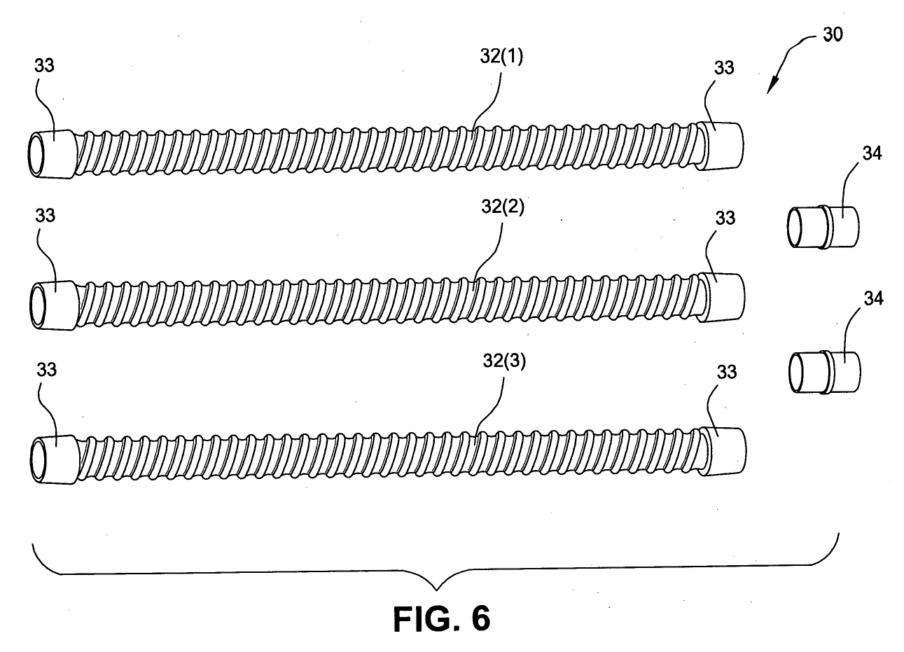

FIG. 6 illustrates an air delivery conduit 30 according to an embodiment of the present invention. As illustrated, the air delivery conduit 30 includes three tubing segments 32(1), 32(2), 32(3) that are connectable to one another by connectors 34, e.g., 360° swivel connectors. However, it should be appreciated that more or less tubing segments may be provided.

Each tubing segment may be constructed of 22 mm smooth bore tubing having silicone end portions or connectors 33. Each tubing segment may have a length of about 2 feet or about 0.4-0.8 m. However, other suitable lengths are possible.

In an embodiment, the air delivery conduit may be provided as a tubing kit including a plurality of tubing segments and a plurality of connectors to interconnect the tubing segment. The kit may include tubing segments of the same length (e.g., each tubing segment is about 0.4-0.8 m), or the kit may include tubing segments of varying lengths (e.g., tubing segment of 0.2-0.5 m, tubing segment of 0.4-0.8 m, etc.). Also, the kit may include tubing segments of similar and/or varying bore sizes. The kit allows the patient to construct an air delivery conduit of customized length and bore size, thereby improving comfort, encouraging patient interaction with their therapy, and usage of the PAP system.

The segmented tubing may be particularly advantageous for use with the pillow or pillow base/insert described above. For example, tubing segments may be coupled together in order to customize the length required to attach the flow generator to an inlet side of the pillow, and tubing segments may be coupled together in order to customize the length required to attach the patient interface to an outlet side of the pillow.

### 4.1.2 Smaller Bore, Segmented Tubing

In an embodiment, smaller bore, segmented tubing may be provided to improve compliance. For example, each tubing segment may be constructed of 15 mm smooth bore tubing. The smaller bore tubing reduces the size and weight of the tubing, thereby facilitating use and compliance.

The smaller bore, segmented tubing may be particularly advantageous for use in attaching the patient interface to an outlet side of the pillow. For example, 15 mm bore tubing segments may be coupled together in order to customize the length required to attach the patient interface to an outlet side of the pillow. The smaller, lighter weight tubing on the interface side of the pillow would encourage compliance and improve the patient's overall experience with PAP therapy.

### 4.1.3 Pillow/Segmented Tubing Combination

As noted above, the combination of the pillow or pillow base/insert and the segmented tubing provides the patient with flexibility and options so that the PAP system can be best customized to improve compliance. In an embodiment, the tubing kit may be provided separately from the pillow or pillow base/insert (e.g., packaged and sold separately). This allows the patient to make independent selections of such components based on a preferred arrangement. Preferably, the total length of tubing (i.e., including the combination of 22 mm segmented tubing, 15 mm segmented tubing, and the tubing or port through the pillow or pillow base/insert) does not exceed about 2.5 m in length or offer options to the patient which may produce sub therapeutic treatment.

### 4.3 Spiral Tubing

In an embodiment, the air delivery conduit may include spiral tubing, e.g., similar to spiral configuration of a telephone cord. The use of such spiral tubing may improve stability and help reduce the drag of the tubing on the patient interface in use.

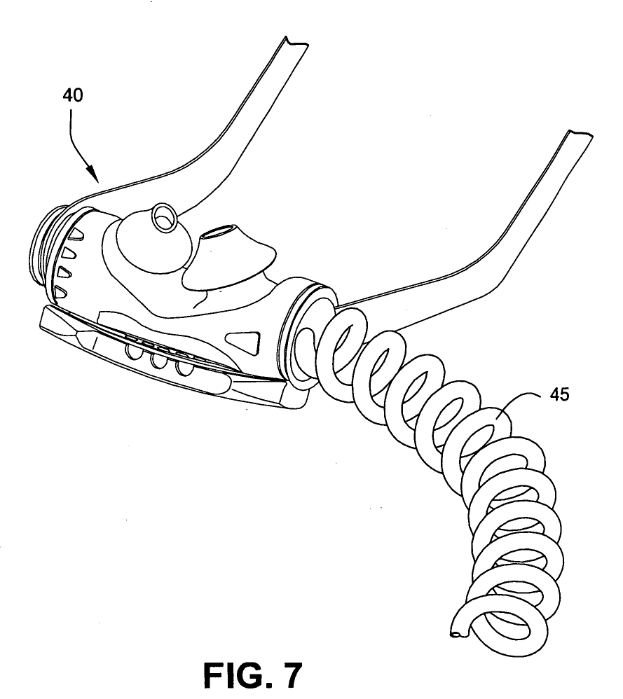

FIG. 7 illustrates a patient interface including a nasal prong arrangement 40 and spiral tubing 45 provided to one end of the nasal prong arrangement 40 for delivering pressurized breathable gas. In an embodiment, the spiral tubing may be spring loaded or biased to keep the tubing compact and neat and to prevent tangling.

The spiral tubing may be particularly advantageous for use with such nasal prong arrangement. Specifically, because tubing for the nasal prong arrangement is asymmetric or provided to only one side of the nasal prong arrangement, typical elongated tubing (e.g., 2 m elongate tubing) may provide enough pass to pull the nasal prong arrangement sideways (e.g., when the patient moves around in bed) which may break the seal between the nasal prongs and the patient's nares. However, the spiral tubing provides a flexible arrangement that allows sufficient extension and retraction of the tubing in use. This arrangement reduces tube drag and effectively decouples the tubing from the nasal prong arrangement to prevent breaking of the seal. However, it should be appreciated that the spiral tubing may be used with other breathing arrangements, e.g., nasal mask, full-face mask, etc.

### 4.4 Magnetic Connection

In the illustrated embodiment, each tube connector, e.g., 360° swivel connector, may be coupled to a respective tube or side of the pillow with a friction fit and/or mechanical interlock, for example. In alternative embodiment, a magnetic connection may be provided between each tube connector and the respective component to provide a quick, convenient, secure attachment. For example, each tube connector may be magnetic and adapted to magnetically couple to a metallic or magnetic portion provided to the respective component, e.g., side of the pillow.

### 5. Tube Retaining Arrangements

The following provides tube retaining arrangements according to embodiments of the present invention. Each tube retaining arrangement is structured to support or retain tubing to reduce tube drag. Tube drag with a patient interface can lead to patient discomfort, air leakage, and poor compliance. This problem may be associated with patient interfaces such as a nasal prong arrangement wherein the low profile design leads to an asymmetrical tubing or air supply route.

### 5.1 Pillow or Mattress Clip

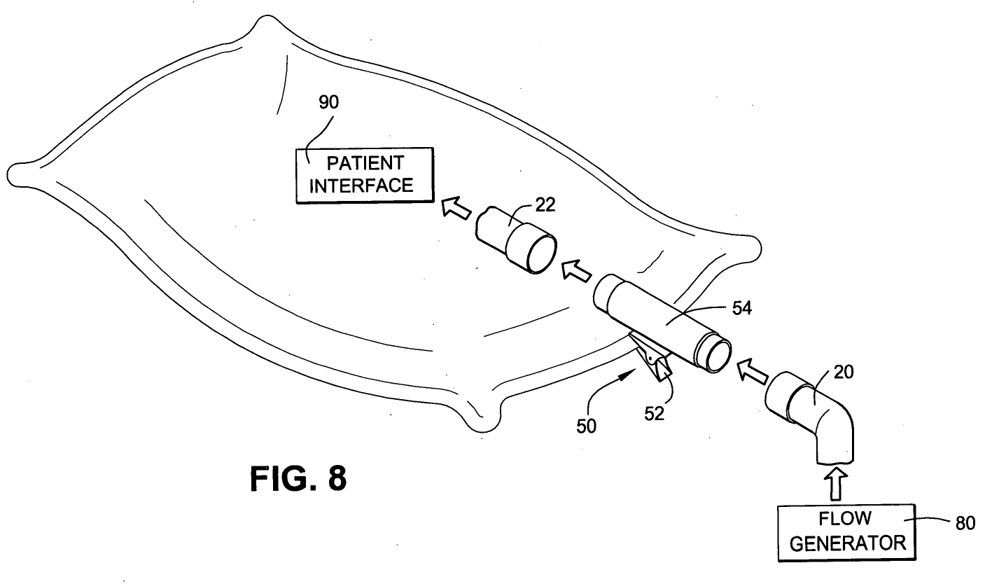

In an embodiment, the tube retaining arrangement may include a clip adapted to attach to a pillow or mattress and support tubing in a manner to reduce tube drag. For example, FIG. 8 illustrates a clip 50 including a clip portion 52 adapted to be attached to the patient's pillow or mattress P and a tube connector portion 54 (e.g., inline with the clip portion). In use, a relatively long tube portion 20 (e.g., 2 m tubing) may be coupled between the flow generator 80 and one side of the connector portion 54, and a shorter tube portion 22 may be coupled between the patient interface 90 and the other side of the connector portion 54. The clip 50 provides an anchoring point for the tubing at one position in the bed (e.g., pillow or mattress), which helps to eliminate or at least reduce tube drag.

### 5.2 Tube Retainer

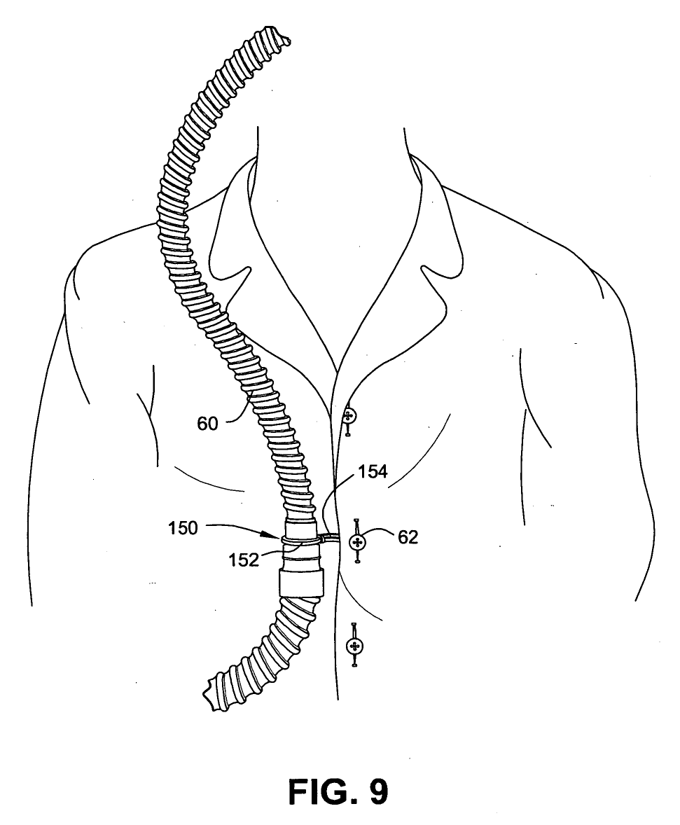

FIG. 9 illustrates a tube retaining arrangement including a tube retainer structured to attach to the patient's shirt or pajamas and support tubing in a manner to reduce tube drag. In the illustrated embodiment, the tube retainer 150 includes an elastomeric loop or band (e.g., rubber band) having a first portion 152 attached to the tubing 60 and a second portion 154 attached to a selected button 62 provided on the patient's shirt or pajamas. As illustrated, the tubing is anchored to a button at about chest height of the patient. However, higher or lower button locations may be selected, e.g., depending on patient comfort. In an embodiment, the second portion 154 may be structured to attach to a metal snap, Velcro™(hook and loop material), or other attachment structure.

In use, the tube retainer 150 decouples the tubing from the headgear, and therefore the tubing does not pull on the headgear and lead to discomfort or leak at the patient interface.

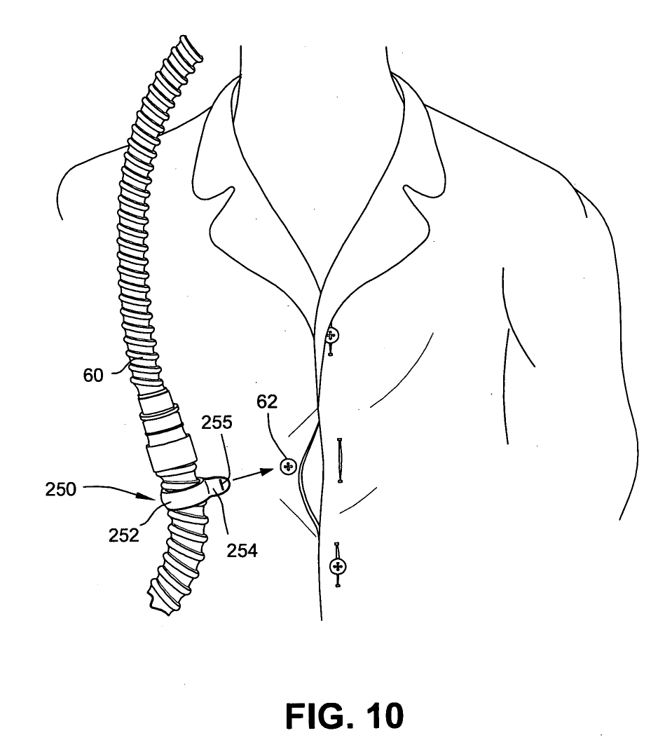

FIG. 10 illustrates a tube retainer 250 according to another embodiment of the present invention. As illustrated, the tube retainer 250 includes a first portion 252 attached to the tubing 60 and a second portion 254 that provides an opening 255 for receiving a selected button 62 provided on the patient's shirt or pajamas. In use, the tube retainer 250 decouples the tubing from the headgear, and therefore eliminates or at least reduces tube drag. Similar to the above, the second portion 254 may be structured to attach to a metal snap, Velcro™, or other attachment structure.

In an embodiment, the tube retainer may be provided as a relatively inexpensive accessory (e.g., packaged and sold separately from the patient interface and tubing). In addition, one or more portions of the tube retainer may be provided with branding, e.g., brand name or logo.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment. In addition, while the invention has particular application to patients who suffer from OSA, it is to be appreciated that patients who suffer from other illnesses (e.g., congestive heart failure, diabetes, morbid obesity, stroke, barriatric surgery, etc.) can derive benefit from the above teachings. Moreover, the above teachings have applicability with patients and non-patients alike in non-medical applications.

What is claimed is:

1. A tubing management system for a CPAP system, comprising:
a pillow including at least one port through an interior portion thereof,
each port including an inlet and an outlet adapted to be coupled to an air delivery conduit to allow the air delivery conduit to be routed through the interior portion.

2. A tubing management system according to claim 1, wherein the pillow includes a soft pliable portion constructed of a low density foam and a core portion constructed of a semi or high density foam, the core portion having a tubular configuration that defines the at least one port.

3. A tubing management system according to claim 2, further comprising a piece of smooth tubing provided to the core portion.

4. A tubing management system according to claim 1, wherein the pillow includes multiple ports that provides multiple inlets and outlets, each of the multiple inlets and outlets adapted to be selectively plugged.

5. A tubing management system according to claim 1, wherein the pillow has a contoured shape structured to extend the patient's head back in such a way to open the patient's upper airway in use.

6. A tubing management system for a CPAP system, comprising:
a base or insert including at least one port through an interior portion thereof, the base or insert adapted to lie under a pillow or mattress and the at least one port adapted to be coupled to an air delivery conduit to allow the air delivery conduit to be routed through the interior portion.

7. A tubing management system according to claim 6, wherein the base or insert is coated with silicone.

8. A tubing management system according to claim 1, wherein the at least one port includes structure adapted to control sound transmission, temperature of the air, and/or or humidity of the air.

9. A tubing management system according to claim 8, wherein a muffler is provided along the at least one port.

10. A tubing management system according to claim 8, wherein a heater is provided along the at least one port.

11. A CPAP system, comprising:
a flow generator;
a patient interface;
an air delivery conduit that interconnects the flow generator and the patient interface; and
a tubing management system according to claim 1.

12. A CPAP system according to claim 11, wherein the air delivery conduit includes a first conduit coupled between the flow generator and a selected inlet side of a selected one of the at least one port and a second conduit coupled between the patient interface and a selected outlet side of the selected port.

13. A CPAP system according to claim 12, further comprising a connector provided to one or both ends of each conduit.

14. A CPAP system according to claim 13, wherein the connector includes a 360° swivel connector.

15. A CPAP system according to claim 11, wherein the air delivery conduit includes two or more tubing segments that are connectable to one another by connectors.

16. A CPAP system according to claim 15, wherein the tubing segments are connectable by 360° swivel connectors.

17. A CPAP system according to claim 15, wherein the tubing segments are constructed of 22 mm bore tubing.

18. A CPAP system according to claim 15, wherein the tubing segments are constructed of 15 mm bore tubing.

19. A CPAP system according to claim 15, wherein each tubing segment includes a length of about 0.4-0.8 m.

20. A tubing kit, comprising:
at least two tubing segments; and
at least one connector adapted to connect the at least two tubing segments to one another to construct a tube of customized length.

21. A tubing kit according to claim 20, wherein the at least two tubing segments include similar lengths.

22. A tubing kit according to claim 20, wherein the at least two tubing segments include varying lengths.

23. A tubing kit according to claim 20, wherein the at least two tubing segments include similar bore sizes.

24. A tubing kit according to claim 20, wherein the at least two tubing segments include varying bore sizes.

25. A CPAP system, comprising:
a flow generator;
a patient interface; and
an air delivery conduit including a spiral configuration that interconnects the flow generator and the patient interface.

26. A CPAP system according to claim 25, wherein the patient interface includes a nasal prong arrangement.

27. A CPAP system according to claim 25, wherein the air delivery conduit provides a flexible arrangement that allows sufficient extension and retraction of the conduit in use.

28. A CPAP system according to claim 25, wherein the air delivery conduit is spring loaded or biased.

29. A tube retainer, comprising:
a clip portion adapted to be attached to the patient's pillow or mattress; and
a tube connector portion adapted to be coupled between first and second tubes, the tube connector portion including a first side structured to be attached to the first tube and a second side structured to be attached to the second tube.

30. A tube retainer according to claim 29, wherein the tube connector portion is positioned inline with the clip portion.

31. A tube retainer, comprising:
a first portion adapted to be attached to a tube; and
a second portion that provides an opening adapted to receive a selected attachment structure provided on the patient's shirt or pajamas.

32. A tube retainer according to claim 31, wherein the selected attachment structure includes a button, metal snap, and/or hook and loop material.

33. A tube retainer according to claim 31, wherein the first and second portions are constructed of an elastomeric material.
